(19) United States
(12) Patent Application Publication
(10) Pub. No.: US 2003/0207092 A1
(43) Pub. Date: Nov. 6, 2003

(54) Picture-on-picture decal sheet

(76) Inventor: Jae Duck Kim, Kyungbuk (KR)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/446,324

(22) Filed: May 27, 2003

Related U.S. Application Data
(62) Division of application No. 10/072,181, filed on Feb. 7, 2002.

(51) Int. Cl. B32B 3/00

(52) U.S. Cl. 428/195.1

(57) ABSTRACT

The present invention relates to a decal sheet. The decal sheet includes an image on a surface, a decal on the image, and another image on the decal.

### FIELD OF THE INVENTION

The present invention relates generally to a decal sheet, and more specifically to a decal sheet having an image of the decal under the decal.

### BACKGROUND OF THE INVENTION

Images appear on various surfaces, e.g., on photographs, greeting cards, baseball cards, pamphlets, etc. The images are fixed onto these surfaces so that the ability to transfer the image onto another surfaces is not possible.

Using stickers, one can transfer images onto different surfaces. Once removed, however, the images of the sticker no longer exist on their original surface.

### SUMMARY OF THE INVENTION

In accordance with methods consistent with the present invention, a method for creating a decal sheet is disclosed. The method includes printing an image on a surface, wherein the image has a shape, coating the surface over the image with release paper, applying adhesive on the release paper over the image, wherein the adhesive is applied in a shape similar to the image shape, applying a base layer on the adhesive, wherein the base layer is applied in a shape similar to the image shape, and printing the image on the base layer, wherein the image on the base layer and the image on the surface coincide.

In accordance with methods consistent with the present invention, a method for creating a decal sheet is disclosed. The method includes printing an image on a surface, applying adhesive on the surface over the image, applying a base layer on the adhesive, and printing the image on the base layer.

In accordance with an embodiment consistent with the present invention, a decal sheet is provided. The decal sheet includes an image on a surface, a decal on the surface over the image, and another image on the decal.

In accordance with another embodiment consistent with the present invention, a decal sheet is provided. The decal sheet includes an image on a surface, a decal on the surface over the image, and another image on the decal. The image has a shape, and the decal has a shape similar to the image shape. The other image is identical to the image and the image and the other image coincide.

In accordance with another embodiment consistent with the present invention, a decal sheet is provided. The decal sheet includes an image on a surface, release paper on the surface over the image, an adhesive layer on the release paper, a base layer on the adhesive layer, and another image on the base layer. The image has a shape, the adhesive layer is formed in a shape similar to the image shape, and the base layer is formed in a shape similar to the image shape. The other image is identical to the image and the image and the other image coincide.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a decal sheet in accordance with the present invention;

FIG. 2 depicts the decal sheet depicted in FIG. 1 with one of the decals removed and a corner of the other decal lifted;

FIG. 3 depicts the layers applied to a surface to create a decal sheet in accordance with methods consistent with the present invention; and

FIG. 4 depicts a flow diagram illustrating the manufacture of a decal sheet in accordance with methods consistent with the present invention.

### DETAILED DESCRIPTION OF THE INVENTION

Reference will now be made in detail to implementations consistent with the present invention as illustrated in the accompanying drawings. Wherever possible, the same reference numbers will be used throughout the drawings and the following description to refer to the same or like parts.

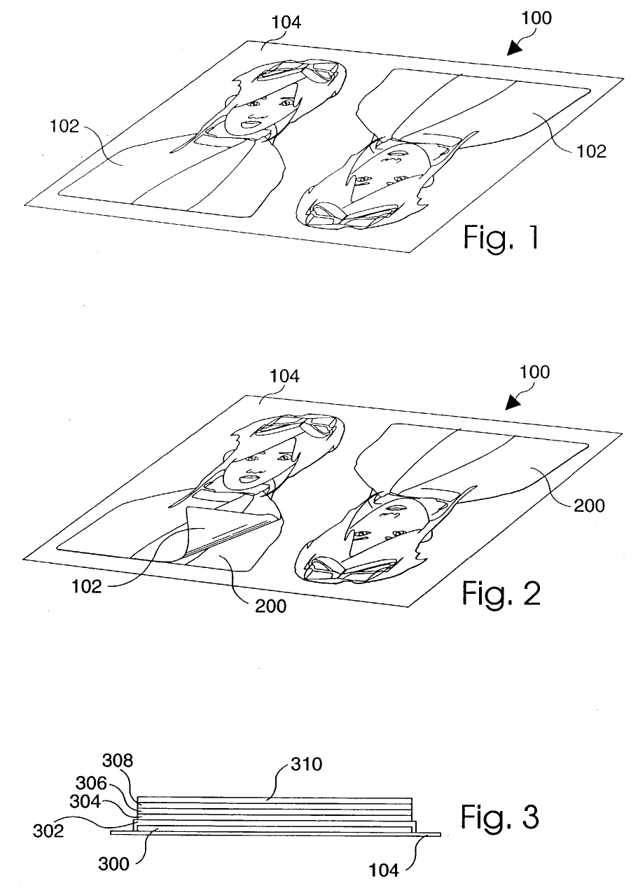

FIG. 1 depicts a decal sheet 100, which includes decals 102 on a surface 104. When the decals 102 are removed from the surface 104, an image 200 remains on the surface 104, as depicted in FIG. 2. Thus, a user can transfer the decal 102 without removing the image 200 from the surface 104. In the example depicted in FIG. 2, the image 200 on the sheet 100 is identical to the image on the decal 102. If the images are identical, one can transfer the image using the decal 102 without permanently removing the image 200 from the surface 104. Although methods and articles of manufacture consistent with the present invention do not require the image 200 on the sheet 100 to be identical to the image on the decal, the remainder of the description discusses an example where both images are identical. In the example shown in FIG. 2, the images also coincide so that the image on the decal 102 is directly above the image 200 on the surface 104.

The decal sheet 100 may take many forms. For example, the decal sheet 100 may be a greeting card that includes an image of the sender on the cover of the card. A recipient of the card may transfer the decal containing the image onto another surface (e.g., onto a refrigerator, a mirror, a cup, or a notebook cover) without removing the image from the greeting card. As another example, the decal sheet 100 may be a page in a book so that the images of different characters in the book may be transferred onto a different surface without removing the images of the characters from the book. Although aspects of the present invention are described as being used on greeting cards and books, one skilled in the art will appreciate that these aspects can also be used on other types of items, such as photographs, baseball cards, pamphlets, advertisements, etc.

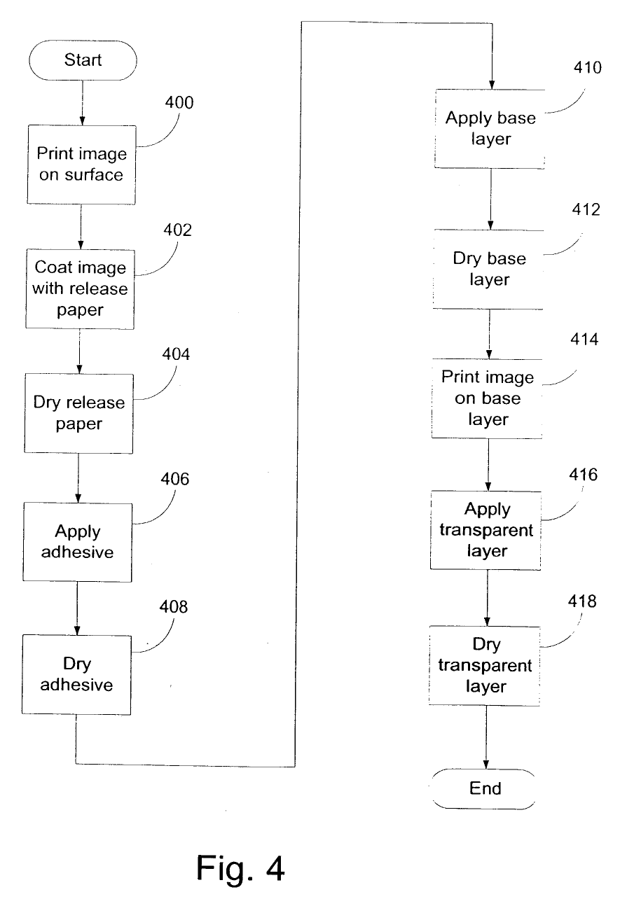

FIG. 3 depicts the various layers of the decal sheet 100, and FIG. 4 depicts a flow diagram illustrating a process that may be used to create the decal sheet 100 in accordance with methods consistent with the present invention. The decal sheet 100 is formed on a surface 104. The surface 104 in this example is depicted as a flat sheet, e.g., the surface 104 may comprise a paper-like material such as art paper or cast coated paper. One of ordinary skill in the art, however, will recognize that any surface may be used, as discussed above.

Initially an image 300 is printed onto the surface 104 (step 400). Any conventional printing method may be used to print the image 300 onto the surface 104, e.g., offset printing, silk screening, gravure, letterpress, a color scanner, etc. Next, the decal is formed on the image 300. Any conventional method of forming a decal may be used to create a decal or sticker on the surface 104 in accordance with methods and articles of manufacture consistent with the present invention. For example, U.S. Pat. Nos. 5,021,275 and 5,169,681 disclose methods of creating an ornamental sticker that do not require a separate cutting process, both of which are incorporated herein by reference.

Returning to the method disclosed in FIG. 4, the next step is to coat the image 300 with release paper 302 (step 402). The release paper 302 makes it easier to remove the decal 102 from the surface 104. Thus, the release paper extends at least slightly beyond the outer edge of the image, as depicted in FIG. 3, and may cover the entire surface 104. The release paper may include teflon, silicone, fluoride, silicone resin, fluorine resin, or any coating material used as a releasing agent, and may be applied using a silk screen process, offset printing process or a coating process. After the release paper is coated on the image, the release paper is dried (step 404). The release paper may be dried using heat or ultraviolet light.

Next, adhesive 304 is applied onto the release paper 302 (step 406). The adhesive 304 may be applied in the same shape as the image 300. The adhesive may be an aqueous adhesive, e.g., an acrylic acid ester polymer, or it may be an oily adhesive. The adhesive may be applied using a silk screen process. After the adhesive 304 is applied, the adhesive 304 is dried (step 408). The adhesive 304 may be dried using heat or ultraviolet light.

The next step is to apply a base layer 306 (step 410). A plurality of base layers may be applied to increase the thickness of the decal 100. The base layer(s) may be opaque or transparent. If the base layer(s) is transparent, the image on the decal will appear on both sides of the decal. Thus, if the decal is applied on a transparent object, e.g., on glass, the image on the decal may be seen from both sides of the object. The base layer 306 may be applied in the same shape as the image 300, and may be applied using a silk screen process. The base layer 306 may include polyvinyl chloride (PVC), acryl, urethane, polyurethane or a resin. After each base layer 306 is applied, the base layer 306 is dried (step 412). The base layer 306 may be dried using heat or ultraviolet light.

After the base layer dries, another image 308 is printed on the base layer 306 (step 414). The other image 308 may be identical to and may coincide with image 300. Any conventional printing method may be used to print the image 308 on the base layer 306, e.g., offset printing, silk screening, gravure, letterpress, a color scanner, etc. Finally, a transparent layer 310 may be applied to the image 308 (step 416). The transparent layer 310 may include polyurethane or a resin. The transparent layer 310 is then dried (step 418). The transparent layer 310 may also be dried using heat or ultraviolet light.

Although the surface 104 of the decal sheet 100 was depicted as a sheet of paper, one skilled in the art will recognize that the surface 104 may be part of a separate product, e.g., a baseball card, etc. Thus, the decal sheets and methods consistent with the present invention are not limited to those used in the present embodiment.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A decal sheet comprising:
an image on a surface, wherein the image has a shape;
release paper on the surface over the image;
an adhesive layer on the release paper, wherein the adhesive layer is formed in a shape similar to the image shape;
a base layer on the adhesive layer, wherein the base layer is formed in a shape similar to the image shape; and
another image on the base layer, wherein the other image is identical to the image and wherein the image and the other image coincide.

2. The decal sheet of claim 1, wherein the release paper comprises teflon, silicone, fluoride, silicone resin, fluorine resin, or any coating material used as a releasing agent.

3. The decal sheet of claim 1, wherein the release paper is formed by a silk screen process, an offset printing process, or a coating process.

4. The decal sheet of claim 1, wherein the adhesive layer is formed by a silk screen process.

5. The decal sheet of claim 1, wherein the base layer is formed by a silk screen process.

6. The decal sheet of claim 1, further comprising a plurality of base layers.

7. The decal sheet of claim 1, wherein the base layer comprises polyvinyl chloride, acryl, urethane, polyurethane or a resin.

8. The decal sheet of claim 1, wherein the image is printed on the surface by offset printing, silk screening, gravure, a letterpress, or a color scanner.

9. The decal sheet of claim 1, wherein the adhesive layer comprises an aqueous adhesive or an oily adhesive.

10. The decal sheet of claim 11, wherein the aqueous adhesive comprises an acrylic acid ester polymer.

11. The decal sheet of claim 1, wherein the base layer is transparent.

12. The decal sheet of claim 1, wherein the base layer is opaque.

13. A decal sheet comprising:
an image on a surface, wherein the image has a shape;
a decal on the surface over the image, wherein the decal has a shape similar to the image shape; and
another image on the decal, wherein the other image is identical to the image and wherein the image and the other image coincide.

14. The decal sheet of claim 13, wherein the release paper comprises teflon, silicone, fluoride, silicone resin, fluorine resin, or any coating material used as a releasing agent.

15. The decal sheet of claim 13, wherein the release paper is formed by a silk screen process, an offset printing process, or a coating process.

16. The decal sheet of claim 13, wherein the adhesive layer is formed by a silk screen process.

17. The decal sheet of claim 13, wherein the base layer is formed by a silk screen process.

18. The decal sheet of claim 13, further comprising a plurality of base layers.

19. The decal sheet of claim 13, wherein the base layer comprises polyvinyl chloride, acryl, urethane, polyurethane or a resin.

20. The decal sheet of claim 13, wherein the image is printed on the surface by offset printing, silk screening, gravure, a letterpress, or a color scanner.

21. The decal sheet of claim 13, wherein the adhesive layer comprises an aqueous adhesive or an oily adhesive.

22. The decal sheet of claim 21, wherein the aqueous adhesive comprises an acrylic acid ester polymer.

23. The decal sheet of claim 13, wherein the base layer is transparent.

24. The decal sheet of claim 13, wherein the base layer is opaque.

25. A decal sheet comprising:
an image on a surface;
a decal on the surface over the image; and
another image on the decal.

26. The decal sheet of claim 25, wherein the image is identical to the other image.

27. The decal sheet of claim 25, wherein the image and the other image coincide.

28. The decal sheet of claim 25, wherein the release paper comprises teflon, silicone, fluoride, silicone resin, fluorine resin, or any coating material used as a releasing agent.

29. The decal sheet of claim 25, wherein the release paper is formed by a silk screen process, an offset printing process, or a coating process.

30. The decal sheet of claim 25, wherein the adhesive layer is formed by a silk screen process.

31. The decal sheet of claim 25, wherein the base layer is formed by a silk screen process.

32. The decal sheet of claim 25, further comprising a plurality of base layers.

33. The decal sheet of claim 25, wherein the base layer comprises polyvinyl chloride, acryl, urethane, polyurethane or a resin.

34. The decal sheet of claim 25, wherein the image is printed on the surface by offset printing, silk screening, gravure, a letterpress, or a color scanner.

35. The decal sheet of claim 25, wherein the adhesive layer comprises an aqueous adhesive or an oily adhesive.

36. The decal sheet of claim 35, wherein the aqueous adhesive comprises an acrylic acid ester polymer.

37. The decal sheet of claim 25, wherein the base layer is transparent.

38. The decal sheet of claim 25, wherein the base layer is opaque.

39. A method of creating a decal sheet, the method comprising the steps of:
printing an image on a surface, wherein the image has a shape;
coating the surface over the image with release paper;
applying adhesive on the release paper over the image, wherein the adhesive is applied in a shape similar to the image shape;
applying a base layer on the adhesive, wherein the base layer is applied in a shape similar to the image shape; and
printing the image on the base layer, wherein the image on the base layer and the image on the surface coincide.

40. The method of claim 39, further comprising the step of drying the release paper before applying the adhesive.

41. The method of claim 40, wherein the release paper is dried using heat or ultraviolet light.

42. The method of claim 39, further comprising the step of drying the adhesive before applying the base layer.

43. The method of claim 42, wherein the adhesive is dried using heat or ultraviolet light.

44. The method of claim 39, further comprising the step of drying the base layer before printing the image on the base layer.

45. The method of claim 44, wherein the base layer is dried using heat or ultraviolet light.

46. The method of claim 39, further comprising the step of applying a transparent layer over the image on the base layer.

47. The method of claim 46, further comprising the step of drying the transparent layer.

48. The method of claim 47, wherein the transparent layer is dried using heat or ultraviolet light.

49. The method of claim 46, wherein the transparent layer comprises polyurethane or a resin.

50. A method of creating a decal sheet, the method comprising the steps of:
printing an image on a surface;
applying adhesive on the surface over the image;
applying a base layer on the adhesive; and
printing the image on the base layer.

51. The method of claim 50, further comprising the step of drying the adhesive before applying the base layer.

52. The method of claim 51, wherein the adhesive is dried using heat or ultraviolet light.

53. The method of claim 50, further comprising the step of drying the base layer before printing the image on the base layer.

54. The method of claim 53, wherein the base layer is dried using heat or ultraviolet light.

55. The method of claim 50, further comprising the step of coating the surface over the image with release paper before applying the adhesive.

56. The method of claim 55, further comprising the step of drying the release paper.

57. The method of claim 56, wherein the release paper is dried using heat or ultraviolet light.

58. The method of claim 50, further comprising the step of applying a transparent layer over the image on the base layer.

59. The method of claim 58, further comprising the step of drying the transparent layer.

60. The method of claim 59, wherein the transparent layer is dried using heat or ultraviolet light.

61. The method of claim 58, wherein the transparent layer comprises polyurethane or a resin.
